(19) United States
(12) Patent Application Publication
(10) Pub. No.: US 2005/0056739 A1
(43) Pub. Date: Mar. 17, 2005

(54) Retractable support stand

(76) Inventors: Alfred Koning, Glenn, MI (US); Sally J. Koning, Glenn, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/664,997

(22) Filed: Sep. 17, 2003

(51) Int. Cl. F16M 11/38

(52) U.S. Cl. 248/171; 248/188.6

(57) ABSTRACT

A retractable support stand for supporting a multiple or single stage shaft which generally extends vertically above a support surface is provided. The stand includes a yoke including a slidable support collar, an upper slidable retainer ring and an upper fit adapter. The retractable support stand includes more than one support leg having a first end snappably received to the hinge pin(s) within the inwardly projecting slots of the slidable support collar and each support leg also includes an integrally molded foot end for resting upon a support surface. The retractable support stand includes a lower assembly including a leg guide, a lower slidable retainer ring and a lower fit adapter. The leg guide includes a centrally located aperture having an inner wall in communication with lower retainer ring and more than one leg aperture each adapted to receive a leg therein.

### FIELD OF THE INVENTION

The present invention relates to a retractable support stand for generally supporting objects in an upright position.

### BACKGROUND OF THE INVENTION

In general, flag poles, signage, gaming nets, ambulatory aids and the like utilize vertical support shafts which extend generally vertically above a generally horizontal support surface. Such objects having a shaft may be difficult to support without the aid of a human or without leaning or propping the shaft against a separate stationary object. A known way of supporting a support shaft of a pole, signage or gaming nets may typically require a blunt base end which contacts a support surface and several outwardly extending ropes, cables, or other flexible supports which extend from a position above the blunt base on the shaft to stakes or other securing devices positioned about a support surface. This “rope and stake” method requires a lengthy setup time and a vast amount of space because of the cumbersome rope and stake configuration. The configuration may also be dangerous causing harm (i.e., causing people and/or animals to trip and fall) to people and/or animals that are not aware of this rope and stake configuration. Generally, the rope and stake method also requires that the stakes be repositioned several times to assure that the support shaft is generally vertical to the support surface.

Alternatively, the poles, signage and gaming net support shafts may utilize a weighted base support which is typically heavy, space consuming, and difficult and cumbersome to move from one location to another. The weighted base configuration may also be dangerous to move resulting in injury from lifting, rolling or wheeling from one location to another.

Other objects having a shaft which extends generally vertically above a support surface may include ambulatory aids. As the median age of the population increases, so does the need for and use of ambulatory aids, such as crutches, walkers and a variety of canes. While walkers and quad canes remain stable and upright when not in use, standard monopod, and single tip canes do not. Rather they must be balanced, leaned, hung or otherwise stowed with, against or in conjunction with other objects. All of these means are precarious and inconvenient to the user.

There is a need for a retractable support stand designed to fit a multiple stage, or single stage, single head shaft. Such a support stand allows secure storage when the stand is not in use and has the ability to fit more than one size shaft of a particular device to which the stand is attached. Such a stand could be attached to flag poles, signage, gaming nets, ambulatory aids, etc., each having a multiple stage or single stage shaft.

### SUMMARY OF THE INVENTION

The retractable support stand generally includes a yoke. The yoke includes a slidable support collar, an upper slidable retainer ring and an upper fit adapter. The slidable support collar has an outer wall. The support collar also includes a plurality of slots projecting inwardly from the outer wall with a hinge pin extending across each slot, and an inner wall. The retractable support stand also includes more than one support leg for generally supporting an object in an upright position. The retractable support stand includes a lower assembly including a leg guide, a lower slidable retainer ring and a lower fit adapter. The leg guide includes a centrally located aperture. The leg guide further includes more than one leg aperture each adapted to receive a support leg.

Another aspect of the present invention is to provide an ambulatory aid having an upper shaft, including a human contact area; a lower shaft, having a ground contact area; and a retractable support stand. The retractable support stand includes a yoke. The yoke includes a slidable support collar, an upper slidable retainer ring and an upper fit adapter. The slidable support collar includes an outer wall and a plurality of inwardly projecting slots from the outer wall. Each slot includes a hinge pin which extends across each slot. The slidable support collar further includes an inner wall. The retractable support stand also includes more than one support leg. The retractable support stand includes a lower assembly having a leg guide, a lower slidable retainer ring and a lower fit adapter. The leg guide has a centrally located aperture. The leg guide further includes more than one leg aperture each adapted to receive a support leg therein.

Another aspect of the present invention is to provide a method for supporting an ambulatory aid. Such a method includes providing an ambulatory aid having an upper shaft including a human contact portion, a lower shaft including a ground contact portion, and a retractable support stand. The retractable support stand includes a yoke. The yoke includes a slidable support collar, an upper slidable retainer ring and an upper fit adapter. The slidable support collar has an outer wall. The slidable support collar further includes a plurality of slots projecting inwardly from the outer wall, wherein each slot includes a hinge pin extending across the slot. Each hinge pin has a midway point. The retractable support stand also includes more than one support leg. Each support leg includes a first end having a recess and an integrally molded foot end for contacting a support surface. The first recessed end of each support leg is rotatably received and rotatably attached to the hinge pin(s) of the inwardly projecting slots of the slidable support collar. The retractable support stand further includes a lower assembly including a leg guide, a lower slidable retainer ring and a lower fit adapter. The leg guide has a centrally located aperture and more than one leg aperture. Each leg aperture has a center point and is adapted to receive a supporting leg therein. The total distance between each of the center points of the leg apertures is greater than the total distance between each of the midway points of each of the hinge pins. In order to support the ambulatory aid in a generally upright position on the support legs, a user slides the slidable support collar toward the ground contact portion of the lower shaft of the ambulatory aid so the second end of the support legs extends at least beyond the ground contact area of the lower shaft. The ambulatory aid then will freely stand.

The present inventive retractable support stand may be easily and conveniently fitted to objects having a multiple stage or single stage shaft, which extends generally vertically above a support surface, such as flag poles, signage, support shafts for gaming nets and ambulatory aids, or etc. The retractable support stand of the present invention is less cumbersome, is much safer and has superior results as compared to previously used support devices.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a perspective view of the retractable support stand in its extended position shown attached to an ambulatory aid;

FIG. 2 is a perspective view of the retractable support stand in its retracted position shown attached to an ambulatory aid;

FIG. 3 is a perspective exploded view of the retractable support stand assembly and an ambulatory aid;

FIG. 4 is a top plan view of a support collar;

FIG. 5 is a side view of a support leg; and

FIG. 6 is a top plan view of a leg guide.

### DETAILED DESCRIPTION OF PREFERRED EMBODIMENT

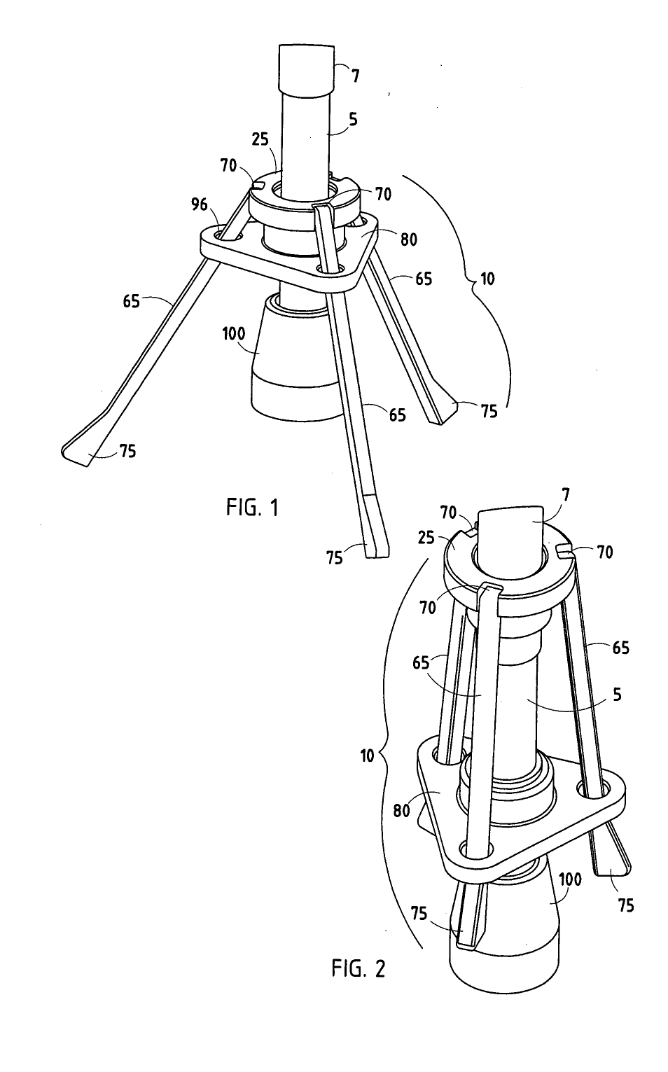

For purposes of description herein, the terms “upper, ” “lower, ” “right, ” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

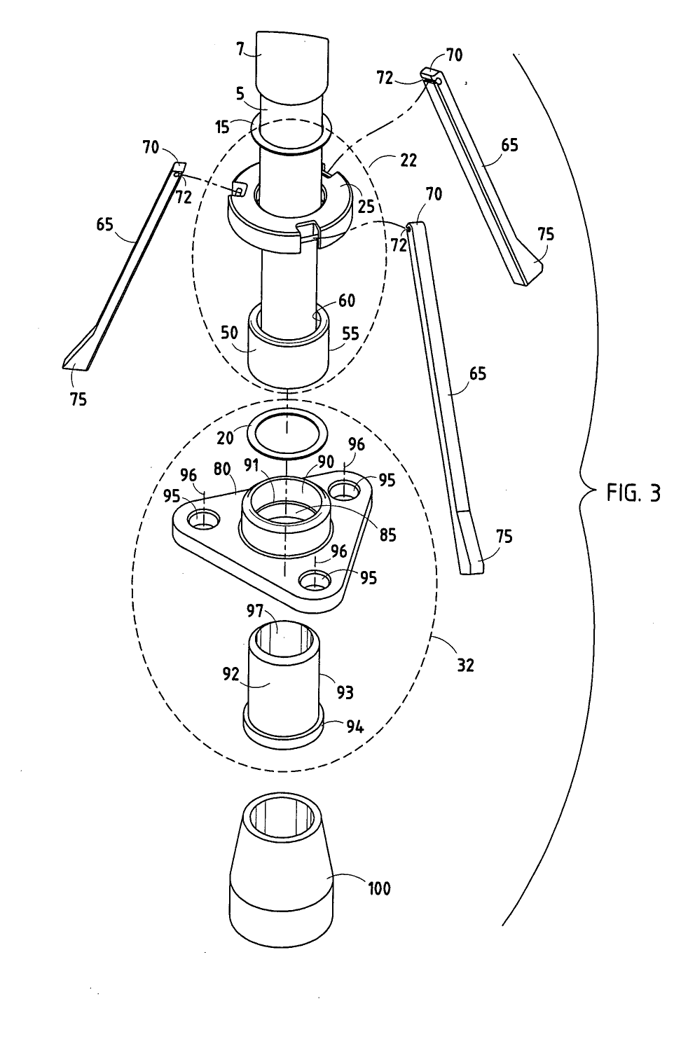

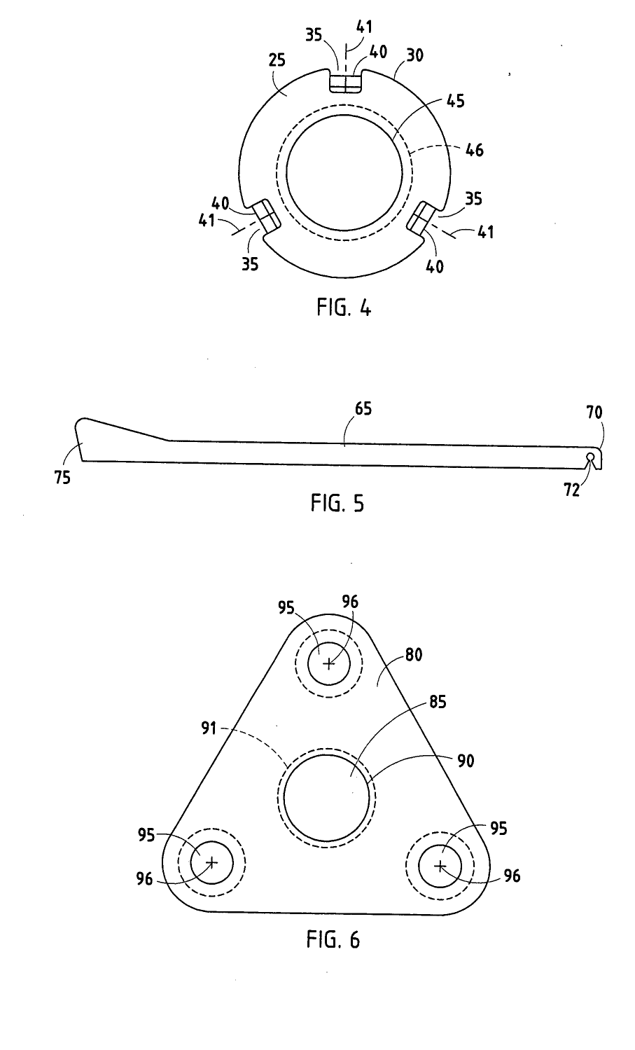

The reference numeral 10 (FIGS. 1 and 2) generally designates a retractable support stand assembly embodying the present invention, which may be used on multiple stage or single stage flag poles, signage, gaming nets, ambulatory aids and the like. Multiple stage devices are those devices that include two or more sized shafts (i.e., each shaft having a different circumference than another) such that one shaft is slidably received in another shaft. In the case of an ambulatory aid, the aid includes an upper shaft 7 having a human contact area and a lower shaft 5. Lower shaft 5 may include a base 100 as a ground contact area. The retractable support stand 10 is depicted in its extended position (FIG. 1) and in its retracted position (FIG. 2). The retractable support stand includes a yoke 22 having a slidable support collar 25, an upper slidable retainer ring 15 and an upper fit adapter 50 (FIGS. 3 and 4). Support collar 25 of yoke 22 has an outer wall 30 which includes a plurality of inwardly projecting slots 35 from outer wall 30. The inwardly projecting slots 35 each include at least one hinge pin 40 extending across slot 35. The support collar 25 also includes an inner wall 45. Inner wall 45 includes upper channel 46 which is in communication with the upper slidable retainer ring 15. Such communication between upper channel 46 and upper slidable, retainer ring 15 may be made permanent by heat sealing, using an adhesive, molding the elements together or otherwise fixedly attaching these elements together. Preferably, upper channel 46 and upper slidable retainer ring 15 are permanently attached. Upper fit adapter 50 of yoke 22 has an outer wall 55 in communication with the upper slidable retainer ring 15, and upper fit adapter 50 also has an inner wall 60 surrounding and in slidable communication with shaft 5. Retractable support stand 10 also includes more than one support leg 65 each including a first end 70 having a recess 72 (FIG. 5). Each support leg 65 is rotationally retained within the inwardly projecting slot 35 by snapping recess 72 of support leg 65 to hinge pin 40 of slidable support collar 25 (FIG. 3). The support leg 65 also includes an integrally molded foot second end 75 for contacting a support surface when retractable support stand 10 is in its extended position.

The retractable support stand 10 also includes a lower assembly 32 having a leg guide 80, a lower slidable retainer ring 20 and a lower fit adapter 92 (FIG. 3). The leg guide 80 has a centrally located aperture 85 extending therethrough for receiving shaft 5 (FIGS. 3 and 6). Leg guide 80 also includes an inner wall 90. Inner wall 90 includes lower channel 91 which is in communication with the lower retainer ring 20. Such communication between lower channel 91 and lower retainer ring 20 may be made permanent by heat sealing, using an adhesive, molding the elements together or otherwise fixedly attaching the elements together. Preferably, lower channel 91 and lower retainer ring 20 are permanently attached. Lower fit adapter 92 of lower assembly 32 has an outer wall 93 in communication with the lower slidable retainer ring 20, and lower fit adapter 92 also has an inner wall 97 surrounding and in slidable communication with shaft 5. Lower fit adapter 92 has a lower lip 94 which allows the lower fit adapter 92 to be inserted a fixed distance into central aperture 85 of leg guide 80 and preventing lower fit adapter 92 from passing all the way through central aperture 85 of leg guide 80. The leg guide 80 also includes at least one leg aperture 95 adapted to receive support leg 65 therethrough. As shown in FIGS. 1-3, retractable support stand 10 preferably includes three support legs 65 extending from support collar 25 of yoke 22 through leg apertures 95 of leg guide 80.

Upper slidable retainer ring 15 and lower slidable retainer ring 20 may be constructed of any material that will allow sliding with upper fit adapter 50 (upper slidable retainer ring) and the lower fit adapter 92 (lower slidable retainer ring), but when at rest will grip and securely position the support collar 25 (upper slidable retainer ring) or leg guide 80 (lower slidable retainer ring) in place. Such materials may include plastic, metal, wood, rubber or any composite or combination thereof, or etc. The upper retainer ring 15 and lower retainer ring 20 are preferably circular in shape and preferably are made of any synthetic or natural rubber or combinations thereof.

Slidable support collar 25 and leg guide 80 may be constructed of any material, including plastic, metal, wood, rubber or any composite or combination thereof, but are preferably constructed of plastic. Slidable support collar 25 and leg guide 80 may be any shape including circular, rectangular, square, triangular, oval, trapezoidal, etc., shape. Support collar 25 is preferably circular and leg guide 80 is preferably triangular. Each hinge pin 40 may be constructed of any material, including but not limited to, plastic, metal, wood or any composite or combination thereof, but is preferably constructed of plastic.

To ensure spreading of support legs 65 when retractable support stand 10 is in its extended position, the total distance of the hinge pins 40 from one another will be less than the total distance that the leg apertures 95 on lower leg guide 80 are from one another. Each hinge pin 40 has a midpoint 41 and each leg aperture 95 has a center point 96. Midway point 41 of each hinge pin 40 is approximately located at half the total length of the hinge pin 40. Center point of each leg aperture 95 is approximately center of the leg aperture 95. Referring to FIGS. 4 and 6, the total distance measured from midway point 41 of a first hinge pin 40 to midway point 41 of a second hinge pin 40, to midway point 41 of a third hinge pin 40, and then back to midway point 41 of the first hinge pin 40 will be less than the distance measured from center point 96 of a first leg aperture 95, to center point 96 of a second leg aperture 95, to center point 96 of a third leg aperture 95 and back to center point 96 of the first leg aperture 95.

As the slidable support collar 25 is slid toward the lower leg guide 80, support legs 65 extend, spread apart, and move away from the lower shaft 5 to a desired tripod position. Generally, when retractable support stand 10 is fully extended (FIG. 1) there is a gravitational pressure exerted on slidable support collar 25 and on leg guide 80 which keeps support legs 65 in the extended position. The downward gravitational pressure is then transferred to each support leg 65 thereby transferring its downward pressure to the integrally molded feet 75 of support legs 65. Additionally, the friction between leg guide apertures 95 and support legs 65 extending therethrough and the friction between integrally molded feet and the support surface also aid in keeping the retractable support stand in its extended position.

To retract the support stand 10, the slidable support collar 25 is slid away from the lower leg guide 80. The slidable support collar 25 may be slid away from lower leg guide 80 until the integrally molded feet 75 of support legs 65 contact the lower leg guide 80. Generally, friction between the upper fit adapter 50 and the shaft 5 in combination with the gripping of upper fit adapter 50 by upper slidable retainer ring 15 holds the retractable support stand 10 in a retracted position (FIG. 2).

Upper fit adapter 50 of yoke 22 and lower fit adapter 92 of lower assembly 32 may be utilized to fit the retractable support stand 10 to shafts of various different circumferences. Specifically, inner wall 60 of upper fit adapter 50 and inner wall 97 of lower fit adapter 92 may be sized to surround shafts of various different diameters. Further, when slidable support collar 25 is retracted (i.e., placing the retractable support stand in its retracted position (FIG. 2)), slidable support collar 25 is moved away from base 100 along lower shaft 5, slidable support collar 25 may encounter upper shaft 7 which has a larger circumference than lower shaft 5. Slidable support collar 25 may be moved onto upper shaft 7 by sliding support collar 25 from upper fit adapter 50 on lower shaft 5 to upper shaft 7. This movement occurs by sliding yoke 22 from lower shaft 5 to upper shaft 7, and upper fit adapter 50 remains on shaft 5. Upper slidable retainer ring 15 allows the support collar 25 to be slid from upper fit adapter 50 on shaft 5 onto upper shaft 7 and grip shaft 7 to hold the retractable support stand 10 in a retracted position. Fit adapters 50 and 92 may be necessary to accommodate an adjustable monopod cane or the like. This is advantageous when used on multiple stage shafts such as the shaft shown in FIG. 3. For example, if a shorter person is utilizing an adjustable cane or if an adjustable height gaming net needs to be set in a low height position, the retractable support stand may still be utilized because of the adapter feature. Conversely, for example, if a taller person is utilizing an adjustable cane or if an adjustable height gaming net needs to be set in a high height position, the retractable support stand may still be utilized because of the adapter feature. The support collar 25 and upper slidable retainer ring 15 may be slid off of upper fit adapter 50 onto the upper shaft 7 and utilized by the method described herein. Past support stands do not include these novel and non-obvious features.

The upper fit adapter 50 and lower fit adapter 92 may be constructed of any material, including but not limited to plastic, metal, wood, rubber or any composite or combination thereof, or etc. Preferably, the adapters are constructed of plastic. The upper fit adapter 50 and lower fit adapter 92 are sleeves having an inner circumference and an outer circumference. The inner and outer circumferences of the fit adapters may vary and are not limited herein. The inner circumference slidably fits and surrounds the shaft to which the retractable support stand 10 is attached. The outer circumference fits within the inner edge 45 of support collar 25 (upper fit adapter 50) or the inner wall 90 of centrally located aperture 85 of leg guide 80 (lower fit adapter 92).

In the illustrated example, a user of a monopod cane seeks to vertically balance the cane on a horizontal support surface. Accordingly, the user moves slidable support collar 25 toward the base 100 so that support legs 65 extend further through leg guide 80. The slidable support collar 25 is moved toward base 100 so that at least integrally molded feet 75 of support legs 65 extend beyond the base 100 of shaft 5. A shaft (e.g. ambulatory aid or the like) is then rested upon the support legs 65 in a generally vertical position relative to a generally horizontal support surface.

The present inventive retractable support stand 10 may be easily and conveniently fitted to many objects having a multiple stage or single stage shaft, which extends generally vertically above a generally horizontal support surface, such as flag poles, signage, support shafts for gaming nets and ambulatory aids, or etc. The retractable support stand of the present invention is simpler, less cumbersome, and has superior results upon use as compared to other previously used support devices.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. A retractable support stand comprising:
a yoke including a slidable support collar having an outer wall, the support collar including a plurality of inwardly projecting slots from the outer wall, an upper slidable retainer ring and an upper fit adapter;
more than one support leg; and
a lower assembly including a leg guide, a lower slidable retainer ring and lower fit adapter, wherein the leg guide includes a centrally located aperture and more than one leg aperture each adapted to receive a support leg therethrough.

2. The retractable support stand of claim 1, wherein the inwardly projecting slot of the slidable support collar further includes a hinge pin extending across each slot.

3. The retractable support stand of claim 1, wherein the upper fit adapter includes an outer wall in communication with the upper slidable retainer ring and includes an inner slidable wall.

4. The retractable support stand of claim 2, wherein the support legs comprise a first end including a recess, wherein the recess is snappably received onto the hinge pins within the inwardly projecting slots of the slidable support collar.

5. The retractable support stand of claim 4, wherein the support legs comprise a second end having an integrally molded foot.

6. The retractable support stand of claim 2, wherein the hinge pins each include a midway point.

7. The retractable support stand of claim 1, wherein the more than one leg aperture include a center point.

8. The retractable support stand of claim 7, wherein the total measurement between each of the center points of the leg apertures is greater than the total measurement between each of the midway points of the hinge pins.

9. An ambulatory aid comprising:
a shaft having an upper shaft including a human contact area and a lower shaft having a ground contact area; and a retractable support stand, the retractable support stand including;
a yoke including a slidable support collar having an outer wall, the support collar including a plurality of inwardly projecting slots from the outer wall, an upper slidable retainer ring and an upper fit adapter;
more than one support leg;
a lower assembly including a leg guide, a lower slidable retainer ring and a lower fit adapter, wherein the leg guide includes a centrally located aperture and more than one leg aperture having a center point wherein each leg aperture is adapted to receive a support leg therethrough.

10. The retractable support stand of claim 9, wherein the inwardly projecting slots of the slidable support collar further include a hinge pin extending across each slot.

11. The retractable support stand of claim 9, wherein the upper fit adapter includes an outer wall in communication with the upper slidable retainer ring and including an inner slidable wall.

12. The retractable support stand of claim 11, wherein the support legs comprise a first end including a recess, wherein the recess is snappably received to the hinge pins extending across each slot.

13. The retractable support stand of claim 12, wherein the support legs comprise an integrally molded foot end.

14. The retractable support stand of claim 9, wherein the leg guide rests upon the support legs and the slidable support collar and the leg guide exert a downward gravitational force on the support legs keeping the support legs in an extended position.

15. The retractable support stand of claim 10, wherein the hinge pins each include a midway point.

16. The retractable support stand of claim 15, wherein each of the more than one leg apertures include a center point.

17. The retractable support stand of claim 16, wherein the total measurement between each of the center points of the leg apertures is greater than the total measurement between each of the midway points of the hinge pins.

18. A method of supporting an ambulatory aid comprising the steps of:
providing an ambulatory aid having an upper shaft with a human contact portion, a lower shaft having a ground contact portion; and a retractable support stand, the retractable support stand including;
a yoke including a slidable support collar having an outer wall, an upper slidable retainer ring and an upper fit adapter, the support collar including a plurality of slots projecting inwardly from the outer wall, wherein each slot includes at least one hinge pin, each hinge pin having a midway point;
more than one support leg, wherein each support leg includes a first end having a recess which is snappably received onto a hinge pin of the slidable support collar and includes a second end having an integrally molded foot having a ground contact area;
a lower assembly including a leg guide having a lower slidable retainer ring and a lower fit adapter, wherein the leg guide includes a centrally located aperture and more than one leg aperture, each leg aperture having a center point, adapted to receive a supporting leg therein, wherein the total measurement between each of the center points of the leg apertures is greater than the total measurement between each of the midway points of each of the hinge pins;
sliding the slidable support collar toward the ground contact portion of the lower shaft so the integrally molded foot ends of the support legs extend at least beyond the ground contact area of the lower shaft; and
resting the ambulatory aid on the support legs.

19. The method of claim 18 further comprising an upper fit adapter including an outer wall in communication with the upper slidable retainer ring and including a second slidable inner wall.

20. The method of claim 18, wherein the leg guide rests upon the support legs and the slidable support collar and leg guide exert a downward gravitational force on the support legs keeping the support legs in an extended position.

21. The method of claim 18, wherein the ambulatory aid comprises a single tip cane.
